(19) United States
(12) Patent Application Publication
(10) Pub. No.: US 2011/0095199 A1
(43) Pub. Date: Apr. 28, 2011

(54) METHOD TO MEASURE CURRENT USING PARALLEL PLATE TYPE IONIZATION CHAMBER WITH THE DESIGN OF GUARD ELECTRODE

(75) Inventors: CHIEN-HAU CHU, Taoyuan County (TW); Shi-Hwa Su, Taoyuan County (TW); Ing-Jane Chen, Taoyuan County (TW); Ming-Chen Yuan, Taoyuan County (TW)

(73) Assignee: Institute of Nuclear Energy Research Atomic Energy Council, Executive Yuan, Taoyuan County (TW)

(21) Appl. No.: 12/606,401

(22) Filed: Oct. 27, 2009

(51) Int. Cl. H01J 27/02

(52) U.S. Cl. 250/423 R

(57) ABSTRACT

An ionization chamber includes a chamber, two outer electrode plates and a center electrode plate. The center electrode plate is disposed at the center of the chamber, and signals produced in the chamber can be collected completely by the center electrode plate to avoid signal losses and improve the accuracy of the test result of the ionization chamber. The center electrode plate also can maintain a constant internal volume of the chamber and prevent a change of effective volume within the chamber due to a change of electric field and enhance the stability of the test result of the ionization chamber. A guard electrode is wrapped by an insulation pin of the electrode and the outer insulation ring to form an insulation shield that can greatly reduce current leakage of the protection electrode and improve the accuracy of the test result of the ionization chamber.

### 1. FIELD OF THE INVENTION

The present invention generally relates to an ionization chamber and, more particularly, to an ionization chamber having a guard electrode capable of collecting all signals produced in a chamber to avoid any signal loss and achieve more accurate measurement.

### 2. BACKGROUND OF THE INVENTION

An ionization chamber is usually applied for testing and measuring an output of an irradiation device such as an X-ray machine, a cobalt 60 teletherapy apparatus, a linear accelerator and various radioactive measuring instruments to determine whether or not the irradiation device achieves the expected stability. To maximize the current output of an ionization chamber and minimize the space for a change of reaction, the ionization chamber is generally installed at the geometric center of the front of the irradiation device. Meanwhile, all possible factors causing interferences to the output of the device should be lowered to improve the accuracy of the measurement. To meet the aforementioned requirements, a good ionization chamber should be characterized in that:

1. The wall of the ionization chamber should be as thin as possible to reduce the possibility of output-blocking and spectrum changes. Furthermore, the ionization chamber should come with consistent beam emission ranges and thickness to prevent excessively large changes of the output homogeneity. Please refer to FIGS. 1 and 2 respectively for a schematic view of the structure of a conventional ionization chamber and a cross-sectional view of a second electrode plate of the conventional ionization chamber. The ionization chamber 10 comprises a cylindrical chamber 11 disposed parallel with a first electrode plate 12 as an anode and a second electrode plate 13 as a cathode. The two electrode plates are made of a plastic material. One side of the first electrode plate 12 that faces the chamber 11 is coated with graphite to define a first conductive portion (not shown), and one side of the second electrode plate 13 that faces the chamber 11 is also coated with graphite to define a second conductive portion 131. An inner electrode 1312 and a protection electrode 1313 are formed respectively on the inner and outer side of an insulation ring 1311 on the second conductive portion 131 and separated by the insulation ring 1311. However, the drawback of such arrangement resides on that the area of the inner electrode 1312 becomes smaller due to the installation of the insulation ring 1311 and the protection electrode 1313. The signal collected in the chamber 11 through the signal pin 111 is limited to a part of the ionization signals in an effective electric field between the inner electrode 1312 and the first electrode plate 12, while another part of the ionization signals produced at the protection electrode 1313 cannot not be collected. Thus, such signals become invalid signals that will cause a large error between the actual signals collected by the chamber 11 and the intensity of the emission and will result in inaccurate measurement.

2. The guard electrode 1313 has an effect of keeping an electric field vertical. However, the signals cannot be collected stably when an applied voltage source is changed to cause a change of the signals within an effective range of the electric field in the chamber 11.

3. Since the electric fields applied to the guard electrode 1313 and the inner electrode 1312 have the same electric potential, the installation of the guard electrode 1313 can prevent a current leakage. However, the second electrode plate 13 only has an inner electrode 1312 disposed at its upper layer, and its bottom 132 or its lateral side 133 is made of plastic without any graphite coating. Therefore, there is still a chance for the occurrence of current leakages that will affect the accuracy of collected signals.

In view of the description above, finding a way of overcoming the shortcomings of the conventional ionization chambers becomes an important subject for those skilled in the art, and an ionization chamber that can overcome the drawbacks of the prior art is needed.

### SUMMARY OF THE INVENTION

It is one object of the invention to overcome the drawbacks of the prior art by providing an ionization chamber that can completely and effectively connect ionization signals in a chamber by a center electrode plate to avoid a signal loss and improve the accuracy of the test result of the ionization chamber.

It is another object of the present invention to provide an ionization chamber using a center electrode plate for maintaining a constant volume in the chamber and preventing a change of electric field that may cause a change to the effective volume in the chamber, so as to improve the stability of the test result of the ionization chamber.

It is still another object of the present invention to provide an ionization chamber that has a complete effective guard electrode for isolating any current leakage occurred between the center electrode plate and the outer electrodes and avoiding the possibility of having a current leakage.

In order to achieve the foregoing objectives, the present invention provides an ionization chamber comprising: a chamber, being a hollow body made of conductive metal and comprising a plurality of support pins and a signal pin protruded from an inner wall of said chamber; two outer electrode plates, fixed to upper and lower sides of said chamber respectively, and each having a first conductive portion disposed on one side of said two outer electrode plates and facing said chamber; and a center electrode plate, fixed in said chamber and comprising a second conductive portion, for collecting an ionization signal in said chamber.

### BRIEF DESCRIPTION OF THE DRAWINGS

The objects and spirits of the embodiments of the present invention will be readily understood by the accompanying drawings and detailed descriptions, wherein:

FIG. 1 is a schematic view of a structure of a conventional ionization chamber;

FIG. 2 is a cross-sectional view of a second electrode plate as depicted in FIG. 1;

FIG. 3 is an exploded view of a preferred embodiment of the present invention;

FIG. 4 is a perspective view of FIG. 3;

FIG. 5 is a cross-sectional view of FIG. 4;

FIG. 6 is a bottom view of an internal structure of a support pin;

FIG. 7 is a bottom view of an internal structure of a signal pin; and

FIG. 8 is a schematic view of an application of a preferred embodiment of the present invention.

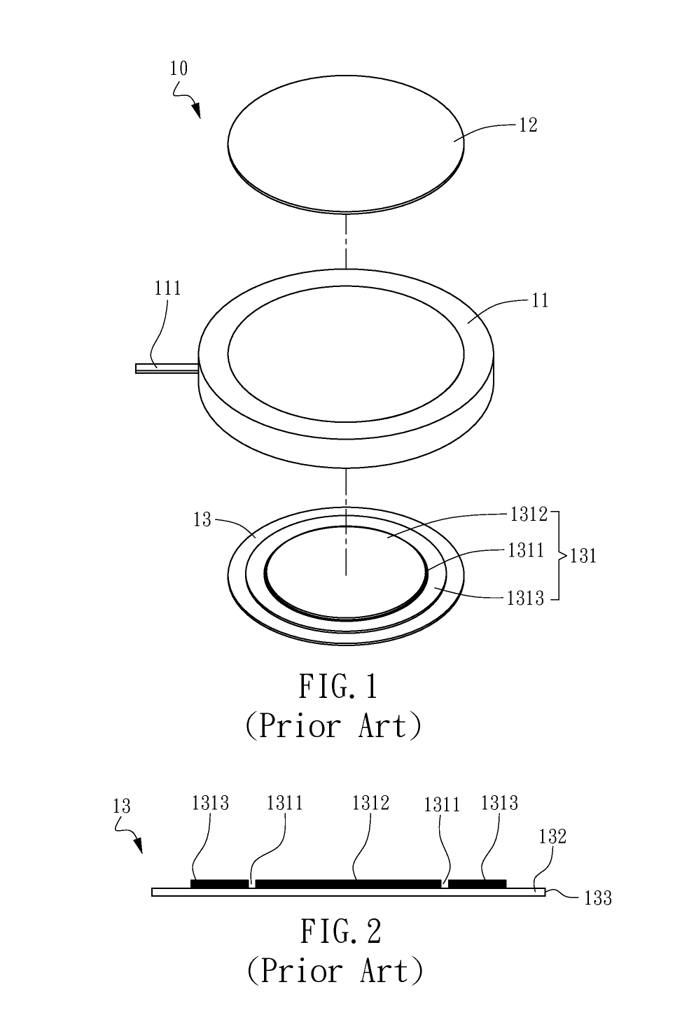

### DETAILED DESCRIPTION OF THE PREFERRED EMBODIMENT

The present invention can be exemplified but not limited by various embodiments as described hereinafter.

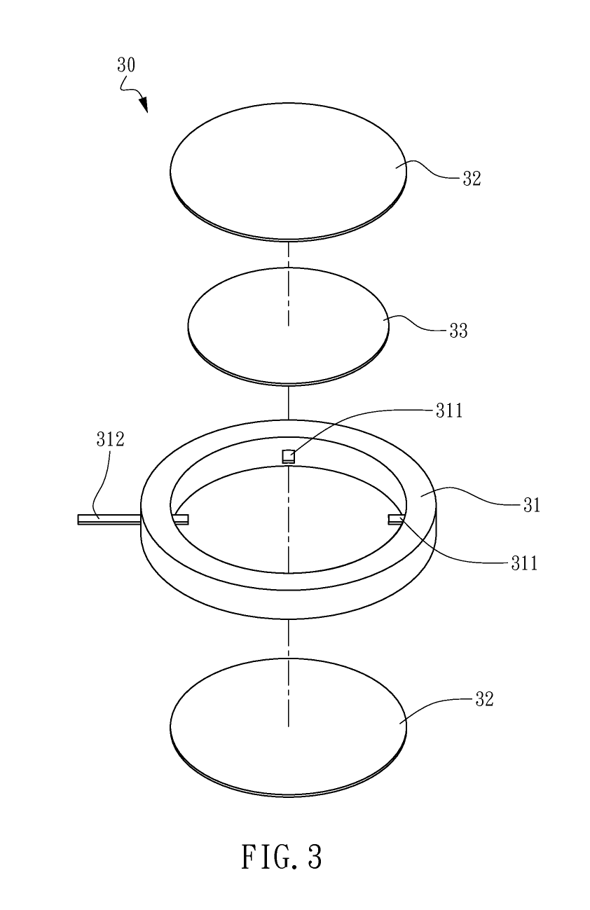

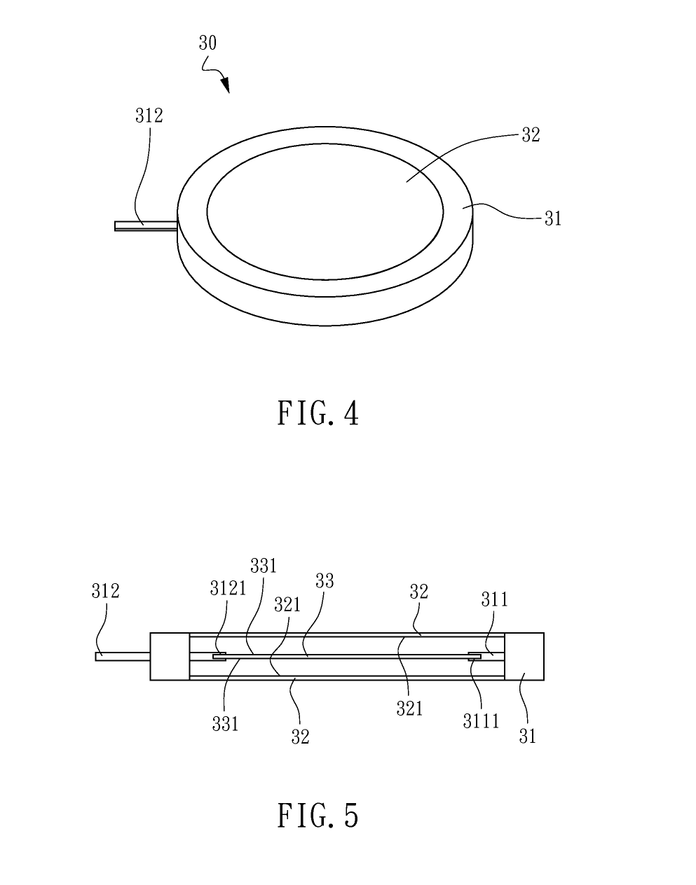

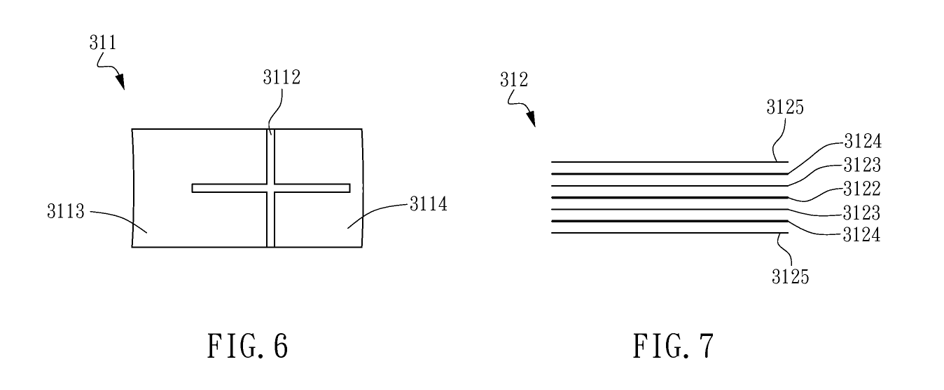

Please refer to FIG. 3 to FIG. 7 respectively for an exploded view of a preferred embodiment, a perspective view of a preferred embodiment, a cross-sectional view of a preferred embodiment, a bottom view of the internal structure of a support pin, and a bottom view of the internal structure of a signal pin in accordance with the present invention. An ionization chamber 30 of the invention comprises a chamber 31, two outer electrode plates 32 and a center electrode plate 33.

The chamber 31 is a cylindrical hollow body made of conductive metal, which could be aluminum, copper, iron or one of combinations thereof. The chamber 31 has a plurality of support pins 311 and a signal pin 312 protruded from the inner wall of the chamber 31. The two outer electrode plates 32 are fixed respectively onto the upper and lower sides of the chamber 31 and made of a plastic material such as a polystyrene film. One side of the chamber 30 is coated with graphite to define a first conductive portion 321. The center electrode plate 33 is fixed in the chamber 31 for collecting ionization signals in the chamber 31 and made of a plastic material, and the whole surface of the center electrode plate 33 is coated with graphite to define a conductor of a second conductive portion 331.

The support pin 311 and the signal pin 312 respectively have an end fixed to the chamber 31, and another end having a slot 3111, 3121 for holding the center electrode plate 33. The support pin 311 comprises a guard electrode 3112, an electrode insulation pin 3113 and an outer insulation ring 3114. The guard electrode 3112 is made of metal such as aluminum, copper, iron, or combinations thereof. Both ends of the guard electrode 3112 are wrapped by the electrode insulation pin 3113 and the outer insulation ring 3114 to define an insulation shield for significantly reducing the current leakage from the guard electrode 3112. Furthermore, the signal pin 312 has a signal line 3122 electrically coupled to the center electrode plate 33 for outputting ionization signals in the chamber 31, and the external edge of the signal line is wrapped sequentially by an inner insulation ring 3123, a guard ring 3124 and an outer insulation ring 3125. These three layers of insulators can lower the possibility of current leakages.

Furthermore, the center electrode plate 33 is clamped by the slots 3111, 3121 of the support pin 311 and the signal pin 312 and fixed into the chamber 31 and disposed equidistantly from the two outer electrode plates 32. In other words, the center electrode plate 33 is installed at an interval of the same height and parallelly between the two outer electrode plates 32. The two outer electrode plates 32 are fixed respectively onto both upper and lower sides of the chamber 31 by screws, and the thickness of the two outer electrode plates is determined by the measured intensity of radiation, and factors such as blocking the output beams, changing the spectrum or losing the electron equilibrium should be taken into consideration. These factors are conventionally known, and thus will not be described herein.

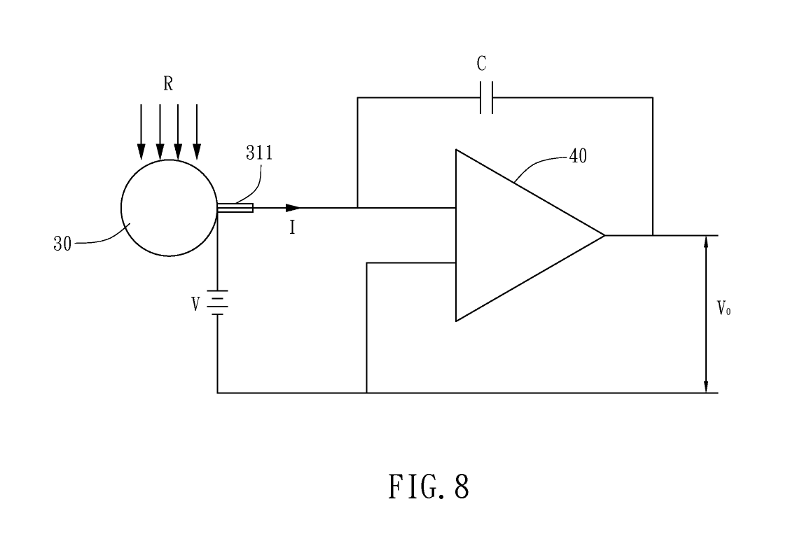

Referring to FIG. 8 for a schematic view of an application of a preferred embodiment of the present invention, the ionization chamber 30 should be installed before use. Firstly, the signal pin 312 of the ionization chamber 30 is connected to an electrometer 40 for supplying a high DC voltage (V), and both of the center electrode plate and the protection electrode of the ionization chamber 30 are connected to the high DC voltage (V) at the same time to maintain the same electric potential. Ion beams are emitted from an ion beam device (not shown) to the ionization chamber 30. The ionization radiation (R) emitted from the ion beams will ionize the air in the chamber, and the high DC voltage (V) will separate anions and cations in the chamber to produce an ionization current (I). The ionization current (I) flows to an input terminal of the electrometer 40 and a charge capacitor (C). An output terminal of the electrometer 40 receives a voltage output (Vo) for determining the intensity of the ionization radiation (R) emitted by the irradiation device.

In view of the description above, the center electrode plate is installed in the chamber, and thus the ionization signals produced in the chamber can be collected completely by the center electrode plate. The invention does not only avoid signal loss, but also improves the accuracy of the test result of the ionization chamber. On the other hand, the center electrode plate can maintain a constant volume in the chamber and improve the stability of the test result of the ionization chamber by avoiding a change of the electric field and a change of the effective volume in the chamber. Furthermore, the protection electrode is wrapped by the electrode insulation pin and the outer insulation ring so that an insulation shield is formed between both ends of the protection electrode and the center electrode plate to siignificantly reduce the possibility of current leakages from the protection electrode. Such arrangement also improves the accuracy of the test result of the ionization chamber.

The present invention discloses an ionization chamber having a guard electrode capable of collecting all signals produced in a chamber to avoid any signal loss and achieve more accurate measurement. Therefore, the present invention is useful, novel and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. An ionization chamber, comprising:
a chamber, being a hollow body made of conductive metal and comprising a plurality of support pins and a signal pin protruded from an inner wall of said chamber;
two outer electrode plates, fixed to upper and lower sides of said chamber respectively, and each having a first conductive portion disposed on one side of said two outer electrode plates and facing said chamber; and
a center electrode plate, fixed in said chamber and comprising a second conductive portion, for collecting an ionization signal in said chamber.

2. The ionization chamber as recited in claim 1, wherein said conductive metal is one selected from a group consisting of aluminum, copper, iron, and combination thereof.

3. The ionization chamber as recited in claim 1, wherein said two outer electrode plates are made of plastic.

4. The ionization chamber as recited in claim 1, wherein said first conductive portion is made of graphite.

5. The ionization chamber as recited in claim 1, wherein said center electrode plate is made of plastic.

6. The ionization chamber as recited in claim 1, wherein said second conductive portion is made of graphite.

7. The ionization chamber as recited in claim 1, wherein said center electrode plate and said two outer electrode plates are disposed equidistantly with each other.

8. The ionization chamber as recited in claim 1, wherein said support pin further comprises a guard electrode pin and an insulator.

9. The ionization chamber as recited in claim 8, wherein said guard electrode pin is made of metal.

10. The ionization chamber as recited in claim 9, wherein said metal is one selected from a group consisting of aluminum, copper, iron and combination thereof.
